(19) United States
(12) Patent Application Publication
(10) Pub. No.: US 2020/0367534 A1
(43) Pub. Date: Nov. 26, 2020

(54) CONVENIENT INSTANT TAPIOCA BEVERAGE PACK

(71) Applicant: LIAN FA INTERNATIONAL DINING BUSINESS CORPORATION, TAIPEI CITY (TW)

(72) Inventor: KAI-LUNG CHENG, TAIPEI CITY (TW)

(21) Appl. No.: 16/421,067

(22) Filed: May 23, 2019

(51) Int. Cl. A23L 2/385; A23L 2/52; A23L 2/02; A23L 9/10; B65D 81/34; B65D 75/00; B65D 75/58; A47G 19/22

(52) U.S. Cl. CPC A23L 2/385; A23L 2/52; A23L 2/02; A23L 9/12; A23V 2002/00; B65D 75/008; B65D 75/5816; A47G 19/2222; B65D 81/3461

(57) ABSTRACT

Disclosed is a convenient instant tapioca beverage pack including a food convenience package and a beverage container. The food convenience package includes a sealed packaging bag containing a cooked tapioca pearl food, and the cooked tapioca pearl food includes cooked tapioca pearls and a frozen body of a dipping solution. A store staff can tear a tear notch of the packaging bag and heat up the packaging bag, and then pour the cooked tapioca pearl food contained in the packaging bag into the beverage container after heating, and then add a cold or hot liquid to complete the formulation of the pearl milk tea. Therefore, a particulate beverage such as a pearl milk tea can be formulated conveniently and instantly.

### FIELD OF THE INVENTION

The present invention relates to a tapioca beverage pack, and more particularly to a convenient instant tapioca beverage pack containing two different contents such as tapioca pearl and a cold or hot liquid which are packaged separately, so that a store staff can mix and prepare a tapioca drink instantly in a simple and easy manner.

### BACKGROUND OF THE INVENTION

Taiwan's hand-cranked beverage industry is developed rapidly, particularly pearl milk tea is popular all over the world and widely acclaimed in the East and West. The main ingredients of the pearl milk tea include tapioca pearls, milk tea and syrup, and the tapioca pearls are generally manufactured first and then cook the tapioca pearls with water for a long time to make cooked tapioca pearls, and then the cooked tapioca pearls are cooled by ice water to produce the edible chewy cooked tapioca pearl. However, if the cooked tapioca pearls are not used up immediately, but set aside for a long time or stored in a refrigerator, then the starch in the cooked tapioca pearl will be hardened due to aging and will become not chewy anymore.

The particulate tapioca pearls are mixed with the milk tea to produce the pearl milk tea, and it creates a taste never achieved by traditional beverages, and thus the pearl milk tea is popularly welcome by consumers. Due to the aforementioned formulation method, the pearl milk tea can only be sold in small beverage stores so far, and cannot be marketed in a large quantity over the world.

Since the public security of Taiwan is very good, there are 24-hour convenience stores everywhere, which amaze all foreigners. Besides the 24-hour business operation, Taiwan has many diversified food and stores and various types of daily services, and these convenience stores are good places for solving all kinds of problems of life, and thus many foreign tourists come here for their reputation which is another type of Taiwan's Glory. Therefore, it is an important subject for related industries to find a way of improving the conventional pearl milk tea formulation, combining the particulate beverage such as the pearl milk tea with Taiwan's features with stores for a wide range of operational marketing, allowing individuals to prepare the beverage at home, or promoting this product in the international market.

In view of the aforementioned drawbacks of the conventional way of storing and preparing pearl milk tea and the unsatisfactory design of the overall structure, the inventor of the present invention based on years of experience in the related industry to conduct extensive research and experiment, and finally developed a convenient instant tapioca beverage pack with good logistics, storage, convenient instant formulation, safety and hygiene, and cost-effectiveness to overcome the drawbacks of the prior art.

### SUMMARY OF THE INVENTION

Therefore, it is a primary objective of the present invention is to provide a convenient instant tapioca beverage pack capable of integrating a particulate beverage such as a pearl milk tea with good logistics, storage, convenient and instant formulation, and safety and hygiene with a store to expand the operation and marketing, so as to achieve excellent economic benefits and high practicability.

Another object of the present invention is to formulate the pearl milk tea by a store staff and related equipment easily and conveniently in order to expand the range of both area and time of the business operation, and facilitate the development and expansion of the international market.

A further objective of the present invention is provide a chewy tapioca pearl beverage after the food convenience package is defrosted and heated by microwave for the purpose of drinking and eating.

To achieve the aforementioned and other objectives, the present invention provides a convenient instant tapioca beverage pack comprising a food convenience package and a beverage container. The food convenience package includes a sealed packaging bag, and the packaging bag contains a cooked tapioca pearl food, and the cooked tapioca pearl food includes cooked tapioca pearls and a frozen body of a dipping solution. A store staff may tear a tear notch of packaging bag and perform microwave heating, and then pour the cooked tapioca pearl food contained in the packaging bag into the beverage container after performing microwave heating, and finally add a cold or hot liquid such as milk or fruit juice to complete the formulation of a pearl milk tea.

In this embodiment, the dipping solution is syrup, plant extract liquid or fruit juice/fruit puree.

In this embodiment, the plant extract liquid is coffee, tea, green herbal tea, or milk tea.

In this embodiment, the fruit juice/fruit puree is made of mango, strawberry, pineapple, orange, or other fruits.

In this embodiment, the packaging bag is put into a carrying cup for microwave heating.

In this embodiment, a cup lid is covered onto the beverage container containing the prepared and formulated pearl milk tea, and the cup lid has a straw hole.

In this embodiment, the beverage container forms a sealing film by a sealing machine after the formulation of the pearl milk tea is completed.

### BRIEF DESCRIPTION OF THE DRAWINGS

FIG. 1 is a schematic view of a convenient instant tapioca beverage pack of the present invention;

FIG. 1A is a schematic view of a food convenience package of the present invention;

FIG. 2 is a first schematic view showing a microwave operation of a food convenience package in accordance with the present invention;

FIG. 3 is a second schematic view showing a microwave operation of a food convenience package in accordance with the present invention;

FIG. 4 is a schematic view of a food convenience package after the microwave operation in accordance with the present invention;

FIG. 5 is a schematic view of a food convenience package being poured out after a microwave operation in accordance with the present invention;

FIG. 6 is a schematic view of completing the formulation of a pearl milk tea in accordance with the present invention;

FIG. 7A is a schematic view of covering a cup lid onto a beverage container in accordance with the present invention; and

FIG. 7B is a schematic view of sealing a beverage container in accordance with the present invention.

### DESCRIPTION OF THE PREFERRED EMBODIMENTS

The technical contents of the present invention will become apparent with the detailed description of preferred embodiments accompanied with the illustration of related drawings as follows. It is intended that the embodiments and figures disclosed herein are to be considered illustrative rather than restrictive.

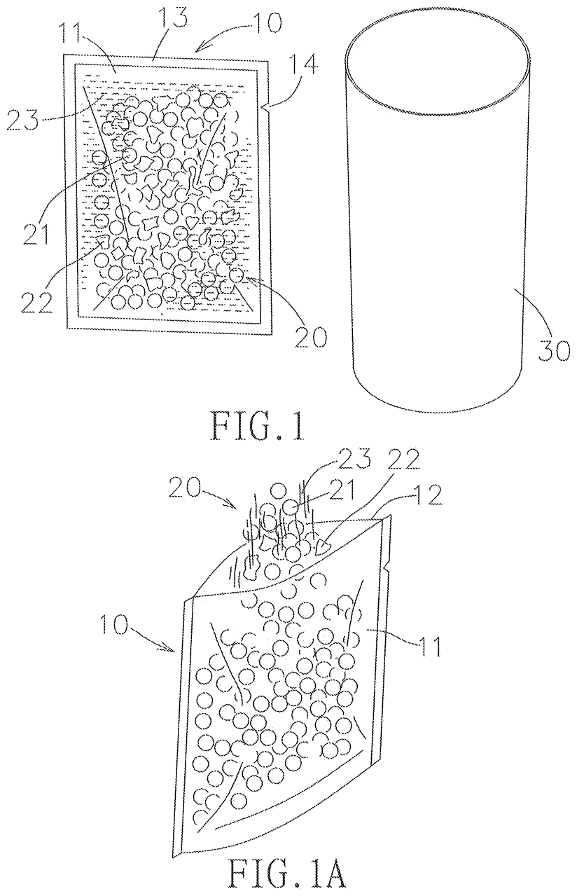

With reference to FIGS. 1 and 1A for a convenient instant tapioca beverage pack in accordance with the present invention, the convenient instant tapioca beverage pack comprises a food convenience package 10 and a beverage container 30, wherein the food convenience package 10 includes a sealed packaging bag 11, and the packaging bag 11 contains a cooked tapioca pearl food 20, and the cooked tapioca pearl food 20 includes a cooked tapioca pearl 21, and a frozen body of a dipping solution 23. In other words, raw tapioca pearls are cooked to produce cooked tapioca pearls 21, and the dipping solution 23 is syrup, plant extract liquid or fruit juice/fruit puree, and the plant extract liquid is coffee, tea, green herbal tea, and milk tea, and the fruit juice/fruit puree is made of mango, strawberry, pineapple, orange or other fruits. The cooked tapioca pearl 21 and the dipping solution 23 are mixed, formulated, and dipped for freezing. In an exemplary embodiment, an edible particulate substance 22 may be added into the cooked tapioca pearl food 20, wherein the edible particulate substance 22 includes but not limited to fruit meats or other starchy foods which add or derive different taste and flavors. The beverage container 30 is provided for containing the cooked tapioca pearl food 20.

In FIG. 1A, the packaging bag 11 is in the shape of a hollow container with an opening 12, and the opening 12 is provided for putting the cooked tapioca pearl 21 and the dipping solution 23 (or the cooked tapioca pearl food 20) therein and then a sealing 13 is carried out for packaging to produce the sealed food convenience package 10. The cooked tapioca pearl food 20 may be packaged into the packaging bag 11 to form the food convenience package 10 manually or automatically (by an automated filling machine, but the invention is not limited to such arrangement). After the sealing 13, a dipping operation is carried out for a period of time. After the dipping, a freezing process is carried out immediately to complete the formation of the food convenience package 10 of tapioca pearls with good flavor in accordance with the present invention. In addition the sealing around the periphery of the food convenience package 10 (or the packaging bag 11) has a tear notch 14 for facilitating users to tear open the food convenience package 10.

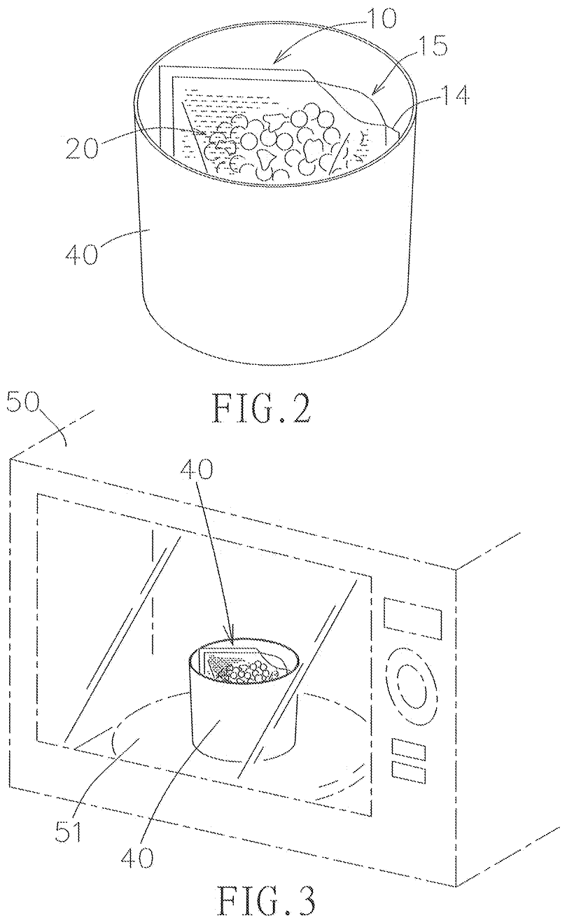

In FIGS. 2 and 3, when the convenient instant tapioca beverage pack of the present invention is opened and used, the frozen food convenience package 10 is torn from the tear notch 14 to form a crevice 15, and then the food convenience package 10 is put into a carrying cup 40, and the carrying cup 40 containing the food convenience package 10 is placed on a turntable 51 in a microwave oven 50 for defrosting the food convenience package 10. In this embodiment, a microwave oven is used for heating. This invention is not limited by such arrangement only, but the frozen food convenience package 10 can also be defrosted by hot water in order to maintain the chewy texture of the cooked tapioca pearl 21 contained in the food convenience package 10 and the hot tapioca pearls 21 and the dipping solution 23 (or added with an edible particulate substance 22) make the formulation of the tapioca pearls with good flavor in simple and convenient manner.

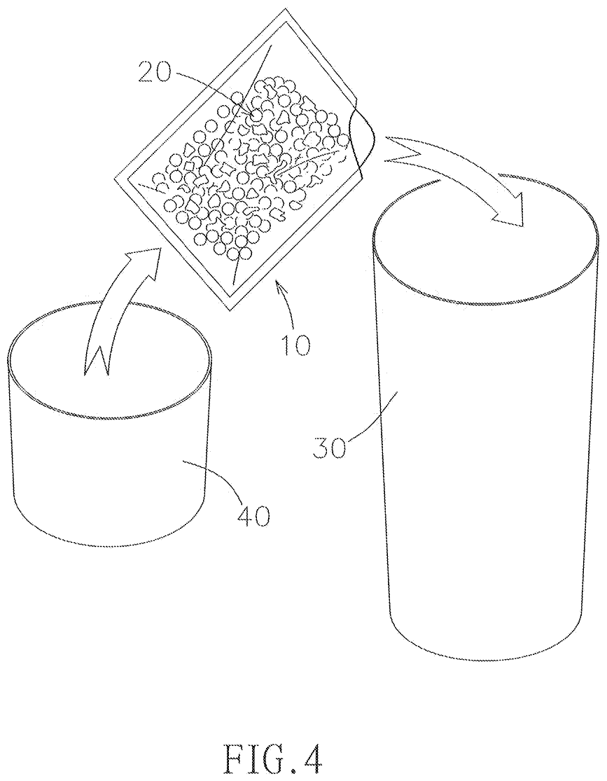

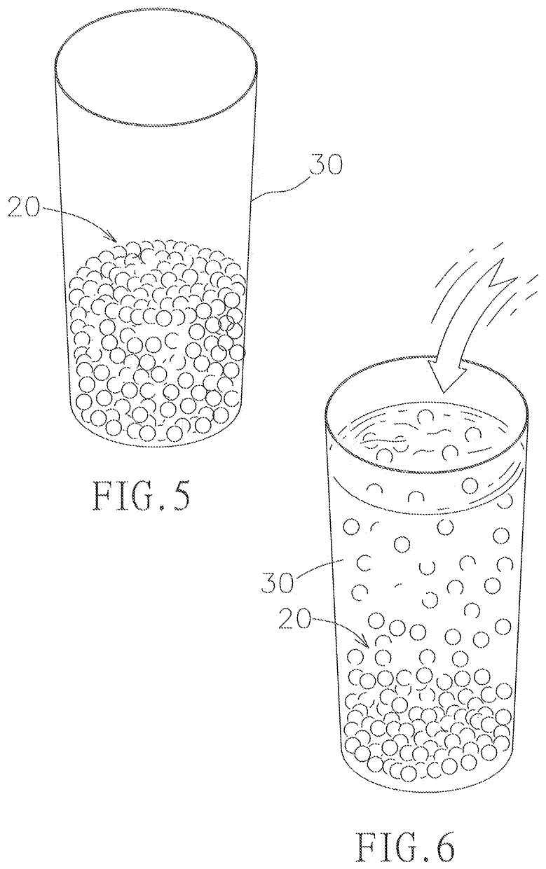

In FIGS. 4 and 5, after the food convenience package 10 defrosted by microwave is taken out from the microwave oven, and the cooked tapioca pearl food 20 contained in the packaging bag 11 is poured into the beverage container 30 (as shown in FIG. 5), the cooked tapioca pearl food 20 is in a liquid form and is an edible food.

In FIG. 6, after the food convenience package 10 is pour into the beverage container 30 and the cold or hot milk or fruit juice is added, the formulation of the pearl milk tea is completed and ready for the purpose of eating. Since the aforementioned formulation process of the tapioca beverage pack of the present invention can be performed by a store staff, and related equipment such as a microwave oven is available in a convenience store, therefore a general store staff can formulate the pearl milk tea easily and conveniently, and thus providing the store the effect of an excellent promotion.

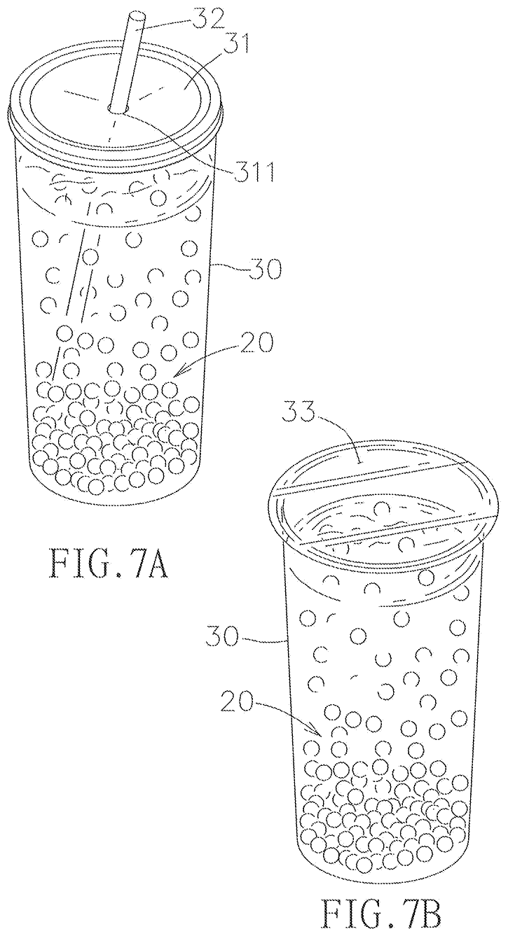

In FIGS. 7A and 7B, after the formulation of the pearl milk tea is completed, a cup lid 31 is covered onto the beverage container 30, wherein the cup lid 31 has a straw hole 311, so that after a drinking straw 32 is inserted into the straw hole 311, the pearl milk tea can be sucked for the purpose of drinking and eating; or a sealing film 33 is formed on the beverage container 30 by a sealing machine and the drinking straw 32 is pieced into the sealing film 33, the pearl milk tea can be sucked for the purpose of drinking and eating.

The convenient instant tapioca beverage pack of the present invention makes the particulate beverage such as the pearl milk tea to have excellent logistics, storage, convenient and instant formulation, and safety and hygiene and integrate the convenient instant tapioca beverage pack with convenience stores to expand the operation and marketing, so as to achieve excellent economic benefits and high practicability. In the meantime, the present invention formulates the pearl milk tea by a store staff and related equipment easily and conveniently in order to expand the range of both area and time of the business operation, and facilitate the development and expansion of the international market.

While the invention has been described by means of specific embodiments, numerous modifications and variations could be made thereto by those skilled in the art without departing from the scope and spirit of the invention set forth in the claims.

What is claimed is:

1. A convenient instant tapioca beverage pack, comprising:
a food convenience package, including a sealed packaging bag, and the packaging bag containing a cooked tapioca pearl food, the cooked tapioca pearl food having a cooked tapioca pearl and a frozen body of a dipping solution; and
a beverage container;
wherein a store staff tears a notch of the packaging bag to perform microwave heating, and then pours the cooked tapioca pearl food contained in the packaging bag into the beverage container after the microwave heating, and then adds a cold or hot liquid to complete preparing the formulation of the pearl milk tea for eating.

2. The convenient instant tapioca beverage pack according to claim 1, wherein the dipping solution is syrup, plant extract liquid, or fruit juice/fruit puree.

3. The convenient instant tapioca beverage pack according to claim 2, wherein the plant extract liquid is coffee, tea, green herbal tea, or milk tea.

4. The convenient instant tapioca beverage pack according to claim 2, wherein the fruit juice/fruit puree is made of mango, strawberry, pineapple or orange.

5. The convenient instant tapioca beverage pack according to claim 1, wherein the cooked tapioca pearl food further includes an edible particulate substance.

6. The convenient instant tapioca beverage pack according to claim 1, wherein the microwave heating of the packaging bag is performed by putting the packaging bag in a carrying cup.

7. The convenient instant tapioca beverage pack according to claim 1, wherein the cold or hot liquid is cold or hot milk or a fruit juice.

8. The convenient instant tapioca beverage pack according to claim 7, wherein the beverage container is covered with a cup lid after the formulation of the pearl milk tea is completed, and the cup lid has a straw hole.

9. The convenient instant tapioca beverage pack according to claim 7, wherein the beverage container is sealed by a sealing machine to form a sealing film after the preparation of the pearl milk tea is completed.
